(19) United States
(12) Patent Application Publication
(10) Pub. No.: US 2025/0390649 A1
(43) Pub. Date: Dec. 25, 2025

(54) RECORDING MEDIUM STORING PROGRAM, METHOD, AND CALCULATION DEVICE

(71) Applicant: SUMITOMO ELECTRIC INDUSTRIES, LTD., Osaka (JP)

(72) Inventor: Takeshi KAWASAKI, Osaka (JP)

(73) Assignee: SUMITOMO ELECTRIC ELECTRIC INDUSTRIES, LTD., Osaka (JP)

(21) Appl. No.: 19/213,298

(22) Filed: May 20, 2025

(30) Foreign Application Priority Data
Jun. 24, 2024 (JP) 2024-101447

(51) Int. Cl. G06F 30/32; G06F 30/27

(52) U.S. Cl. CPC G06F 30/32; G06F 30/27

(57) ABSTRACT

A non-transitory computer-readable recording medium having stored therein a program for causing a computer to execute a process. The process includes acquiring first information about bonding wires other than a number of the bonding wires, and the second information about the number of the bonding wires, the bonding wires being connected between a first port and a second port, and estimating, from the first information based on a trained model, a first parameter, a second parameter, or a third parameter, and calculating a calculation parameter that is the circuit parameter for the number of the bonding wires, based on the parameter from the second information. The trained model is generated by performing machine learning on training data defining a relationship of the first information and the number of the bonding wires to the circuit parameter for the first information and the number of the bonding wires.

### CROSS REFERENCE TO RELATED APPLICATIONS

This application is based on and claims priority to Japanese Patent Application No. 2024-101447 filed on Jun. 24, 2024, and the entire contents of the Japanese patent application are incorporated herein by reference.

### TECHNICAL FIELD

The present disclosure relates to recording media storing programs, methods, and calculation devices.

### BACKGROUND

In a high-frequency circuit, it is known to use a bonding wire as an inductor (for example, patent literature: Japanese Unexamined Patent Application Publication No. 2022-138983).

### SUMMARY

An embodiment according to the present disclosure is a non-transitory computer-readable recording medium having stored therein a program for causing a computer to execute a process. The process includes acquiring first information about one or more bonding wires other than a number of the one or more bonding wires, and second information about the number of the one or more bonding wires, the one or more bonding wires being connected side by side between a first port and a second port, and estimating, from the first information based on a trained model, at least one parameter of a first parameter that is a circuit parameter between the first port and the second port when the number of the one or more bonding wires is one, a second parameter that is the circuit parameter when the number of the one or more bonding wires is N1 that is two or more, or a third parameter that is the circuit parameter when the number of the one or more bonding wires is N2 that is more than N1, and calculating a calculation parameter that is the circuit parameter for the number of the one or more bonding wires indicated by the second information, based on the at least one parameter from the second information. The trained model is generated by performing machine learning on training data, the training data each defining a relationship of the first information and the number of the one or more bonding wires to the circuit parameter obtained for the first information and the number of the one or more bonding wires when the number of the one or more bonding wires is one, N1, and N2.

The present disclosure can be implemented not only as such a characteristic recording medium storing a program, but also as a calculation device and a method that carry out such characteristic steps. Furthermore, it can be implemented as a semiconductor integrated circuit that implements part or all of the calculation device, or as a calculation system that includes the calculation device.

### BRIEF DESCRIPTION OF THE DRAWINGS

FIG. 1A is a schematic diagram of bonding wires for estimating a circuit parameter in a first embodiment.

FIG. 1B is an A-A cross-sectional view of FIG. 1A.

FIG. 2 is a circuit diagram of a semiconductor device.

FIG. 3 is a plan view of a semiconductor device.

FIG. 4 is an A-A cross-sectional view of FIG. 3.

FIG. 5 is a diagram showing Re(Y12) versus the number of bonding wires N in a simulation.

FIG. 6 is a diagram showing Im(Y12) versus the number of bonding wires N in a simulation.

FIG. 7 is a block diagram of a computer in the first embodiment.

FIG. 8 is a flowchart showing a method of generating training data in a first embodiment.

FIG. 9 is a diagram showing an example of training data in a first embodiment.

FIG. 10 is a flowchart showing a method of generating a trained model in a first embodiment.

FIG. 11 is a functional block diagram of a calculation device in a first embodiment.

FIG. 12 is a flowchart showing a method of calculating a Y-parameter in the first embodiment.

FIG. 13 is a flowchart showing a method of generating a trained model in a first modification of a first embodiment.

FIG. 14 is a flowchart showing a method of calculating a Y-parameter in a first modification of the first embodiment.

FIG. 15 is a schematic diagram showing Im(Y12) versus the number N of bonding wires in a second embodiment.

FIG. 16 is a diagram showing an example of training data in a second embodiment.

FIG. 17 is a flowchart showing a method of calculating a Y-parameter in a second embodiment.

FIG. 18 is a schematic diagram of bonding wires for estimating a circuit parameter in a third embodiment.

FIG. 19 is a schematic view of bonding wires.

FIG. 20 is a diagram showing an example of training data in a third embodiment.

FIG. 21 is a flowchart showing a method of generating a trained model in a third embodiment.

FIG. 22 is a flowchart showing a method of calculating a Y-parameter in a third embodiment.

### DETAILED DESCRIPTION

When the high-frequency circuit is designed, the bonding wire is modeled and used. When the bonding wire is modeled using an equivalent circuit model represented by a lumped element circuit, it is not possible to express high-frequency characteristics with high accuracy over a wide bandwidth. When the bonding wire is modeled using a circuit parameter such as an S-parameter, a Y-parameter, or a Z-parameter, the high-frequency characteristics can be expressed with high accuracy in a wide bandwidth. However, when attempting to calculate a highly accurate circuit parameter in the case where a large number of bonding wires are connected side by side, huge amounts of data may have to be collected. Thus, it is difficult to calculate the circuit parameters with high accuracy.

An object of the present disclosure is to provide a program, a method, and a calculation device capable of calculating a circuit parameter of a bonding wire with high accuracy.

### DESCRIPTION OF EMBODIMENTS OF PRESENT DISCLOSURE

First, embodiments of the present disclosure will be listed and described.

(1) An embodiment according to the present disclosure is a non-transitory computer-readable recording medium having stored therein a program for causing a computer to execute a process. The process includes acquiring first information about one or more bonding wires other than a number of the one or more bonding wires, and the second information about the number of the one or more bonding wires, the one or more bonding wires being connected side by side between a first port and a second port, and estimating, from the first information based on a trained model, at least one parameter of a first parameter that is a circuit parameter between the first port and the second port when the number of the one or more bonding wires is one, a second parameter that is the circuit parameter when the number of the one or more bonding wires is N1 that is two or more, or a third parameter that is the circuit parameter when the number of the one or more bonding wires is N2 that is more than N1, and calculating a calculation parameter that is the circuit parameter for the number of the one or more bonding wires indicated by the second information, based on the at least one parameter from the second information. The trained model is generated by performing machine learning on training data, the training data each defining a relationship of the first information and the number of the one or more bonding wires to the circuit parameter obtained for the first information and the number of the one or more bonding wires when the number of the one or more bonding wires is one, N1, and N2. Thus, the circuit parameter of the bonding wire can be calculated with high accuracy. (2) In the above (1), when the number of the one or more bonding wires indicated by the second information differs from one, N1, and N2, the calculating may calculate the calculation parameter based on the second parameter and the third parameter. Thus, when the number of bonding wires N differs from one, N1, and N2, the circuit parameter can be calculated with high accuracy.

(3) In the above (2), when the number of the one or more bonding wires indicated by the second information is one, the first parameter may be calculated as the calculation parameter. When the number of the one or more bonding wires indicated by the second information is N1, the second parameter may be calculated as the calculation parameter. When the number of the one or more bonding wires indicated by the second information is N2, the third parameter may be calculated as the calculation parameter. Thus, when the number of the one or more bonding wires N differs from one, N1, and N2, the circuit parameter can be calculated with high accuracy.

(4) In any one of the above (1) to (3), the trained model may include a first trained model generated by performing machine learning on first training data, the first training data defining a relationship between the first information and the circuit parameter obtained for the first information when the number of the one or more bonding wires is one, a second trained model generated by performing machine learning on second training data, the second training data defining a relationship between the first information and the circuit parameter obtained for the first information when the number of the one or more bonding wires is N1, and a third trained model generated by performing machine learning on third training data, the third training data defining a relationship between the first information and the circuit parameter obtained for the first information when the number of the one or more bonding wires is N2. When the number of the one or more bonding wires indicated by the second information differs from one, N1, and N2, the estimating may estimate the second parameter based on the second trained model from the first information, and may estimate the third parameter based on the third trained model from the first information. This makes it possible to reduce the amount of data per trained model and reduce the load on the computer.

(5) In any one of the above (1) to (3), the trained model may be one trained model generated by performing machine learning on a plurality pieces of training data, the plurality pieces of training data each defining a relationship of the first information and the number of the one or more bonding wires to the circuit parameter obtained for the first information and the number of the one or more bonding wires. When the number of the one or more bonding wires indicated by the second information differs from one, N1, and N2, the estimating may estimate the second parameter based on the one trained model from the first information and N1 as the number of the one or more bonding wires, and may estimate the third parameter based on the one trained model from the first information and N2 as the number of the one or more bonding wires. Thus, the circuit parameter can be calculated using the one trained model.

(6) In any one of the above (1) to (5), the trained model may be generated by performing machine learning on training data, the training data each defining a relationship of the first information and the number of the one or more bonding wires to the circuit parameter obtained for the first information and the number of the one or more bonding wires when the number of the one or more bonding wires is one, N1, N2, and N3, the N3 being more than N1 and less than N2. When the number of the one or more bonding wires indicated by the second information is less than N3, the estimating may estimate a fourth parameter representing the circuit parameter when the number of the one or more bonding wires is N3, based on the trained model from the first information, and the calculating may calculate the calculation parameter, based on the second parameter and the fourth parameter. When the number of the one or more bonding wires indicated by the second information is more than N3, the estimating estimates the fourth parameter, and the calculating may calculate the calculation parameter based on the fourth parameter and the third parameter. Thus, the circuit parameter of the bonding wires can be calculated with high accuracy.

(7) In any one of the above (1) to (6), the one or more bonding wires may include at least three bonding wires connected side by side between the first port and the second port. Intervals between adjacent bonding wires of the at least three bonding wires may include one or more first intervals having a first length and one or more second intervals having a second length different from the first length. The second information may include a first number representing a number of the first intervals and a second number representing a number of the second intervals. The N1 may correspond to a case in which the first number is N1−1, and the N2 may correspond to a case in which the first number is N2−1. The estimating may estimate, from the first information based on another trained model, at least one parameter of a fourth parameter representing the circuit parameter when the second number is M1 or a fifth parameter that is the circuit parameter when the second number is M2, and the calculating may calculate the calculation parameter that is the circuit parameter for the first number and the second number indicated by the second information, based on the at least one parameter of the first parameter, the second parameter, or the third parameter and the at least one parameter of the fourth parameter or the fifth parameter from the second information. The another trained model may be generated by performing machine learning on another training data, the another training data each defining a relationship of the first information and the second number to the circuit parameter obtained for the first information and the second number when the second number is M1 and M2. Thus, even when the intervals of the bonding wires are different, the circuit parameter of the bonding wire can be calculated with high accuracy.

(8) In any one of the above (1) to (6), the one or more bonding wires may include at least three bonding wires connected side by side between the first port and the second port. Intervals between adjacent bonding wires of the at least three bonding wires may be constant. Thus, the circuit parameter of the bonding wire can be calculated with high accuracy.

(9) In any one of the above (1) to (8), the acquiring may acquire third information about a frequency of a high frequency signal transmitted between the first port and the second port. The estimating may estimate the at least one parameter based on a trained model from the first information and the third information, and the calculating may calculate the calculation parameter based on the at least one parameter from the second information. The trained model may be generated by performing machine learning on a plurality of pieces of training data, the plurality of pieces of training data each defining a relationship of the first information, the frequency, and the number of the one or more bonding wires to the circuit parameter obtained for the first information, the frequency, and the number of the one or more bonding wires when the number of the one or more bonding wires is one, N1, and N2. Thus, the circuit parameter at any frequency can be calculated.

(10) In any one of the above (1) to (9), the circuit parameter may be an S-parameter, a Y-parameter, or a Z-parameter. Thus, the bonding wires can be modeled.

(11) An embodiment according to the present disclosure is a calculation method including acquiring first information about one or more bonding wires other than a number of the one or more bonding wires, and second information about the number of the one or more bonding wires, the one or more bonding wires being connected side by side between a first port and a second port, and estimating, from the first information based on a trained model, at least one parameter of a first parameter that is a circuit parameter between the first port and the second port when the number of the one or more bonding wires is one, a second parameter that is the circuit parameter when the number of the one or more bonding wires is N1 that is two or more, or a third parameter that is the circuit parameter when the number of the one or more bonding wires is N2 that is more than N1, and calculating a calculation parameter that is the circuit parameter for the number of the one or more bonding wires indicated by the second information, based on the at least one parameter from the second information. The trained model is generated by performing machine learning on training data, the training data defining a relationship of the first information and the number of the one or more bonding wires to the circuit parameter obtained for the first information and the number of the one or more bonding wires when the number of the one or more bonding wires is one, N1, and N2. Thus, the circuit parameter of the bonding wires can be calculated with high accuracy.

(12) An embodiment according to the present disclosure is a calculation device including circuitry configured to: acquire first information about one or more bonding wires other than a number of the one or more bonding wires, and second information about the number of the one or more bonding wires, the one or more bonding wires being connected side by side between a first port and a second port; estimate, from the first information based on a trained model, at least one parameter of a first parameter that is a circuit parameter between the first port and the second port when the number of the one or more bonding wires is one, a second parameter that is the circuit parameter when the number of the one or more bonding wires is N1 that is two or more, or a third parameter that is the circuit parameter when the number of the one or more bonding wires is N2 that is more than N1; and calculate a calculation parameter that is the circuit parameter for the number of the one or more bonding wires indicated by the second information, based on the at least one parameter from the second information. The trained model is generated by performing machine learning on training data, the training data defining a relationship of the first information and the number of the one or more bonding wires to the circuit parameter obtained for the first information and the number of the one or more bonding wires when the number of the one or more bonding wires is one, N1, and N2. Thus, the circuit parameter of the bonding wires can be calculated with high accuracy.

(13) An embodiment according to the present disclosure is a calculation device includes a memory and a processor that acquires first information about one or more bonding wires other than a number of the one or more bonding wires, and second information about the number of the one or more bonding wires, the one or more bonding wires being connected side by side between a first port and a second port, and estimates, from the first information based on a trained model, at least one parameter of a first parameter that is a circuit parameter between the first port and the second port when the number of the one or more bonding wires is one, a second parameter that is the circuit parameter when the number of the one or more bonding wires is N1 that is two or more, or a third parameter that is the circuit parameter when the number of the one or more bonding wires is N2 that is more than N1, and calculates a calculation parameter that is the circuit parameter for the number of the one or more bonding wires indicated by the second information, based on the at least one parameter from the second information. The trained model is generated by performing machine learning on training data, the training data defining a relationship of the first information and the number of the one or more bonding wires to the circuit parameter obtained for the first information and the number of the one or more bonding wires when the number of the one or more bonding wires is one, N1, and N2. Thus, the circuit parameter of the bonding wire can be calculated with high accuracy.

### DETAILS OF EMBODIMENTS OF PRESENT DISCLOSURE

Specific examples of a program stored in a recording medium, a method, and a calculation device according to embodiments of the present disclosure will be described below with reference to the drawings. The present disclosure is not limited to these examples, but is defined by the scope of the claims, and is intended to include all modifications within the scope and meaning equivalent to the scope of the claims.

At least some of the embodiments described below may be arbitrarily combined. The calculation device is configured to include a computer, and each function of the calculation device is achieved by a computer program stored in a storage device of the computer being executed by a central processing unit (CPU) of the computer. The computer program may be stored in a storage medium such as a compact disc read only memory (CD-ROM) or a digital versatile disc (DVD).

### First Embodiment

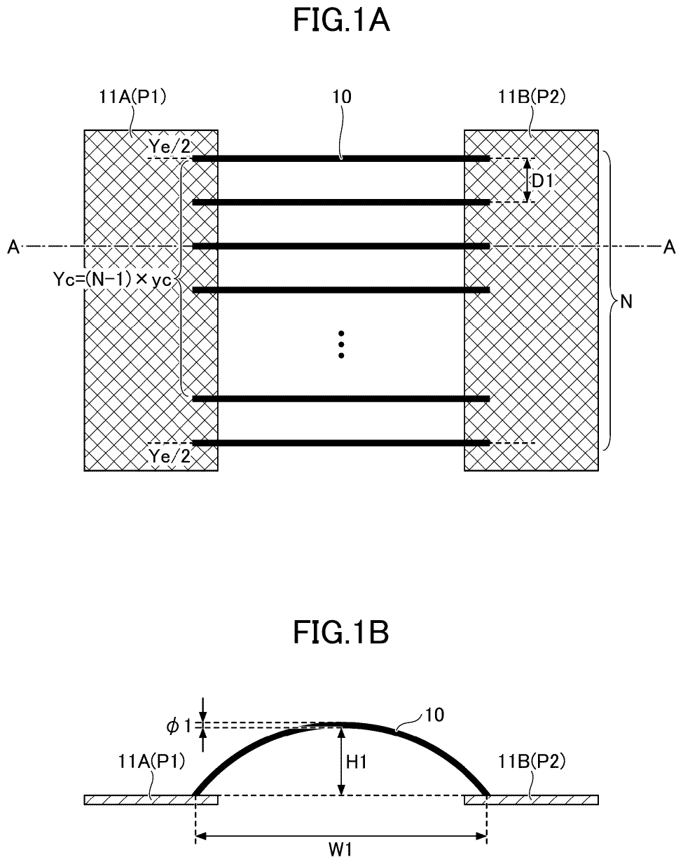

FIG. 1A is a schematic diagram of a bonding wire for estimating a circuit parameter in a first embodiment. FIG. 1B is an A-A cross-sectional view of FIG. 1A. As shown in FIGS. 1A and 1B, N bonding wires 10 are connected side by side between a pad 11A corresponding to a first port P1 and a pad 11B corresponding to a second port P2. A high frequency signal is transmitted from the pad 11A to the pad 11B via the bonding wires 10. The high frequency signal is, for example, microwave (from 300 MHz to 30 GHz) or millimeter wave (from 30 GHz to 300 GHz). A diameter of the bonding wire 10 is 1, a length is W1, a height is H1, and an interval is D1.

(Specific Example in which Bonding Wire is Used)

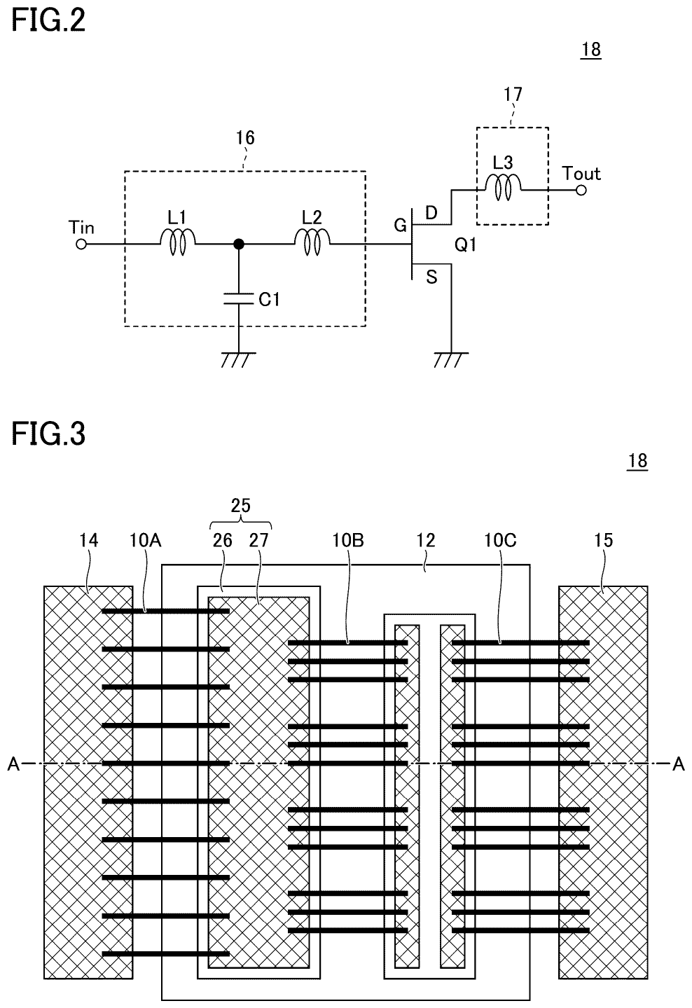

A specific example in which the bonding wire is used will be described by taking a semiconductor device having an amplifier circuit as an example. FIG. 2 is a circuit diagram of a semiconductor device. As shown in FIG. 2, a semiconductor device 18 includes an input terminal Tin, an output terminal Tout, a transistor Q1, and matching circuits 16 and 17. The transistor Q1 has a source S, a gate G, and a drain D. The source S is grounded. The gate G is electrically connected to the input terminal Tin via the matching circuit 16. The drain D is electrically connected to the output terminal Tout via the matching circuit 17. The matching circuit 16 includes inductors L1, L2, and a capacitor C1. The inductors L1 and L2 are connected in series between the input terminals Tin and the gate G. The capacitor C1 is shunt-connected to a node between the inductors L1 and L2. The matching circuit 17 includes an inductor L3. A first end of the inductor L3 is electrically connected to the drain D, and a second end is electrically connected to the output terminal Tout.

The semiconductor device 18 is, for example, an amplifier circuit. A high frequency signal is input to the input terminal Tin. When the semiconductor device 18 is used in a base station for mobile communications, the frequency of the high frequency signal is, for example, from 0.5 GHz to 20 GHz. The high frequency signal is input to the gate G through the matching circuit 16. The matching circuit 16 matches an impedance when matching circuit 16 is viewed from the input terminal Tin with an impedance when the gate G is viewed from the matching circuit 16. The transistor Q1 amplifies the high frequency signal input to the gate G. The amplified high frequency signal is output from the output terminal Tout via the matching circuit 17.

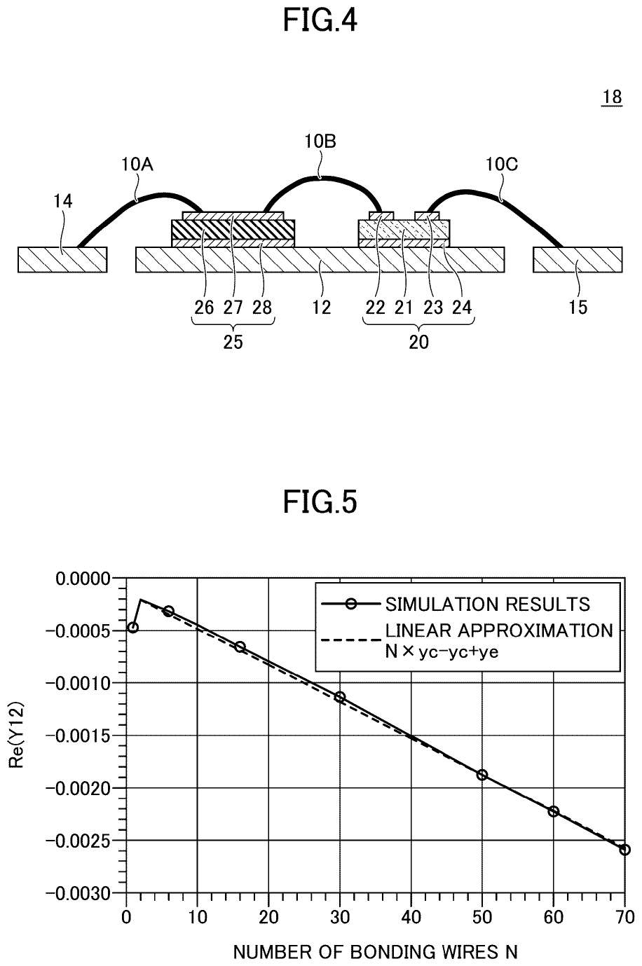

FIG. 3 is a plan view of a semiconductor device. FIG. 4 is an A-A cross-sectional view of FIG. 3. As shown in FIGS. 3 and 4, the semiconductor device 18 includes a base 12, leads 14 and 15, a semiconductor chip 20, a passive chip 25, and bonding wires 10A, 10B, and 10C. The base 12 and the leads 14 and 15 are conductive. The semiconductor chip 20 includes a substrate 21 and electrodes 22 to 24. The electrodes 22 and 23 are provided on the top surface of the substrate 21, and the electrode 24 is provided on the bottom surface of the substrate 21. The passive chip 25 includes a substrate 26 and electrodes 27 and 28. The electrode 27 is provided on the top surface of the substrate 26, and the electrode 28 is provided on the bottom surface of the substrate 26. The electrodes 24 and 28 are bonded onto the base 12 with a conductive bonding layer. The bonding wire 10A electrically connects the lead 14 and the electrode 27. The bonding wire 10B electrically connects the electrodes 27 and 22. The bonding wire 10C electrically connects the electrode 23 and the lead 15.

The leads 14 and 15 correspond to the input terminal Tin and the output terminal Tout, respectively. The bonding wires 10A, 10B, and 10C correspond to inductors L1, L2, and L3, respectively. In the passive chip 25, the substrate 26 and the electrodes 27 and 28 sandwiching the substrate 26 correspond to the capacitor C1. The base 12 is supplied with a reference potential such as a ground potential and corresponds to the ground. The electrodes 22, 23, and 24 of the semiconductor chip 20 correspond to the gate G, the drain D, and the source S of the transistor Q1, respectively.

The base 12 and the leads 14 and 15 are metal plates such as copper plates or laminated plates of copper, molybdenum, and copper plates. The transistor Q1 is, for example, a field effect transistor (FET). The substrate 21 is a semiconductor substrate such as a silicon carbide substrate or a silicon substrate. The substrate 26 is a dielectric substrate such as an alumina substrate or a barium titanate substrate. The electrodes 22 to 24, 27 and 28 are metal layers such as gold layers. The bonding wires 10A, 10B, and 10C are metal thin wires such as gold thin wires or aluminum thin wires.

When the inductors L1 to L3 are used for the matching circuits 16 and 17, for example, it is difficult to design an amplifier circuit unless the high-frequency characteristics of the inductors L1 to L3 are modeled with high accuracy. However, in the semiconductor device 18, the bonding wires 10A (or 10B, 10C) connected side by side are used as the inductor L1 (or L2, L3). In the case of a high-power amplifier circuit, the number of bonding wires 10A (or 10B, 10C) may reach 100 or even 150. As described above, when a large number of bonding wires 10A are connected side by side, it is difficult to model the bonding wires 10A (or 10B, 10C).

As in FIGS. 1A and 1B, a case where a plurality of bonding wires 10 connected side by side between the first port P1 and the second port P2 are modeled is considered. The first conceivable option is to use an equivalent circuit model in which the plurality of bonding wires 10 are represented by a lumped element circuit. However, it is difficult to accurately model the bonding wires 10 by the equivalent circuit model over a wide frequency range. In consideration of this, a further conceivable option is to use circuit parameters such as an S-parameter, a Y-parameter, and a Z-parameter. The circuit parameters between the first port P1 and the second port P2 are measured or simulated for each frequency. Thus, the bonding wires 10 can be modeled with high accuracy over a wide frequency range.

The high-frequency characteristics of the bonding wires 10 depend on the shape of the bonding wires 10 (for example, the diameter φ1, the length W1, the height H1, and the interval D1). Thus, it is considered that a model is created based on a neural network in which the shape of the bonding wire 10, the number N of the bonding wires 10, and a frequency f are set as explanatory variables, and an S-parameter, a Y-parameter, a Z-parameter, or the like is set as an objective variable.

The neural network model is generated based on training data. The training data is created by actual measurement or electromagnetic field analysis while changing the shape of the bonding wire 10, the number N of the bonding wires 10, and the frequency f. However, when a large number of bonding wires 10 are connected side by side, the number N of bonding wires 10 increases. In this case, the number of training data required to create an accurate bonding wire model may be enormous. Further, when the trained model becomes large, the load on the computer becomes large. The first embodiment solves such a problem.

### (Simulation)

In FIGS. 1A and 1B, the number N of the bonding wires 10 is changed, and Y12 is simulated for the Y-parameter between the first port P1 and the second port P2. The shapes of the N bonding wires 10 are assumed to be the same as each other. The frequency is set to 3 GHz.

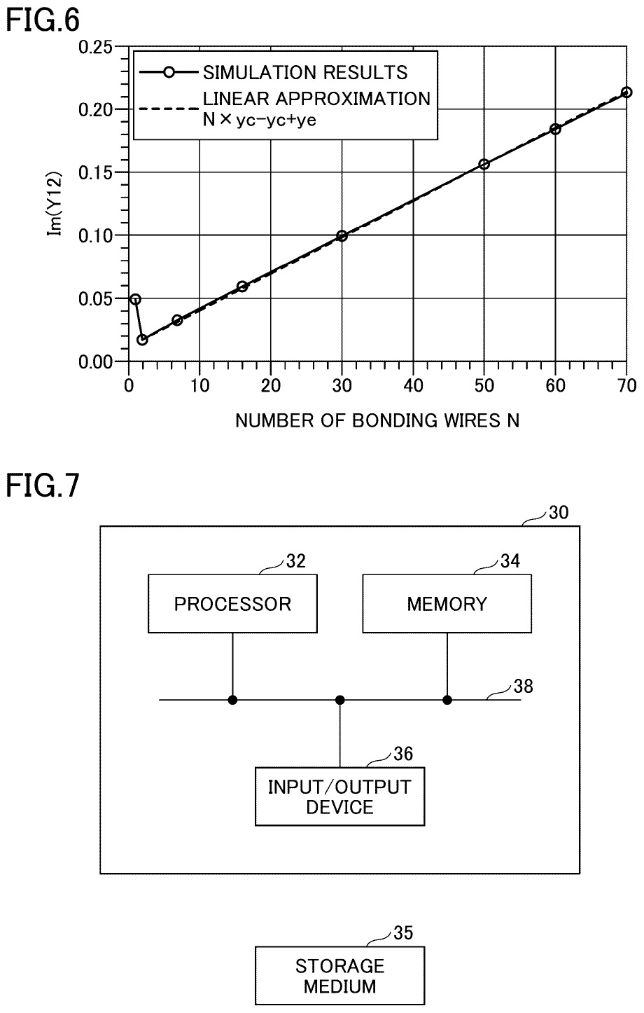

FIG. 5 is a diagram showing Re(Y12) versus the number N of the bonding wires in the simulation. FIG. 6 is a diagram showing Im(Y12) versus the number N of the bonding wires in the simulation. Re(Y12) represents the real part of Y12, and Im(Y12) represents the imaginary part of Y12. The white circles indicate simulated points, and the solid lines are straight lines connecting the white circles. The dashed line is a straight line obtained by linearly approximating white circles except for a circle where N is one. As in FIGS. 5 and 6, Re(Y12) and Im(Y12) except for the case where the number is one can be linearly approximated. A coefficient of determination R² in FIG. 5 is 0.98. A coefficient of determination R² in FIG. 6 is 0.99. When the linearly approximated straight line is represented by N×yc−yc+ye, “yc” corresponds to the slope of the straight line of the dashed line, and “−yc+ye” corresponds to the intercept. When the Y-parameter (for example, Re(Y12) and Im(Y12)) for the number N is YN, YN is expressed by Equation 1.

$$YN = ( N - 1 ) \times yc + ye \qquad ( Equation 1 )$$

### (Principle of Calculating Y-Parameter in First Embodiment)

In FIG. 1A, a Y-parameter Yc inside the outermost bonding wires 10 corresponds to (N−1)×yc, and a Y-parameter outside each of the outermost bonding wires 10 corresponds to ye/2.

When the number of bonding wires 10 is one, a Y-parameter YN is expressed by Equation 2.

$$YN = Y 1 \qquad ( Equation 2 )$$

When the number of bonding wires 10 is N other than one, the Y-parameter YN is expressed by Equation 3.

$$YN = ( N - 1 ) \times yc + ye \qquad ( Equation 3 )$$

Here, YN is one of the elements of the admittance matrix of the Y-parameter, and each of the real and the imaginary parts of Y11, Y12, Y21 and Y22.

The Y-parameter YN for any number N can be calculated from Equation 2 and Equation 3 if a Y-parameter Y1 when N is one, a Y-parameter YN1 when the number N is N1 that is two or more and a Y-parameter YN2 when the number N is N2 that is more than N1 are known.

When N is one, YN can be calculated by Equation 2.

When N is other than one, YN can be calculated by using the following Equation 4.

$$YN = ( N - 1 ) \times ( YN 2 - YN 1 ) / ( N 2 - N 1 ) - ( ( N 1 - 1 ) \times YN 2 - ( N 2 - 1 ) \times YN 1 ) / ( N 2 - N 1 ) \qquad ( Equation 4 )$$

Thus, a model based on a neural network model is proposed in which the explanatory variables are the shapes (for example, the diameter 1, the length W1, the height H1, and the interval D1) of the bonding wires 10 and the frequency f, and the objective variables are Y1, YN1, and YN2. Note that, when the length W1 and the height H1 are determined, the three dimensional shape of the bonding wire 10 is substantially determined. Thus, the three dimensional shape of the bonding wire 10 can be expressed using the length W1 and the height H1. A more detailed three dimensional shape of the bonding wire 10 may be used as an explanatory variable.

Hereinafter, a method of calculating the Y-parameter of the bonding wires 10 in the first embodiment will be described.

### (Block Diagram of Computer)

FIG. 7 is a block diagram of a computer in the first embodiment. A computer 30 functions as a calculation device that calculates the circuit parameters of the bonding wires 10 in cooperation with software. The computer 30 executes the calculation program and executes the calculation method.

The computer 30 includes a processor 32, a memory 34, an input/output device 36, and an internal bus 38. The processor 32 is, for example, a central processing unit (CPU), and executes a program and a method. The memory 34 is, for example, a volatile memory or a nonvolatile memory, and stores data and the like used when the processor 32 executes the program and the method. The memory 34 may store the program executed by the processor 32. The input/output device 36 receives data to be acquired by the processor 32 from the external apparatus, and outputs data output from the processor 32 to the external apparatus. The external apparatus is another computer, another program in the same computer, or the like. The internal bus 38 connects the processor 32, the memory 34, and the input/output device 36, and transmits data and the like. The program is stored in a storage medium 35. The storage medium 35 is, for example, a non-transitory tangible medium, such as a CD-ROM or a DVD.

### (Method of Generating Training Data)

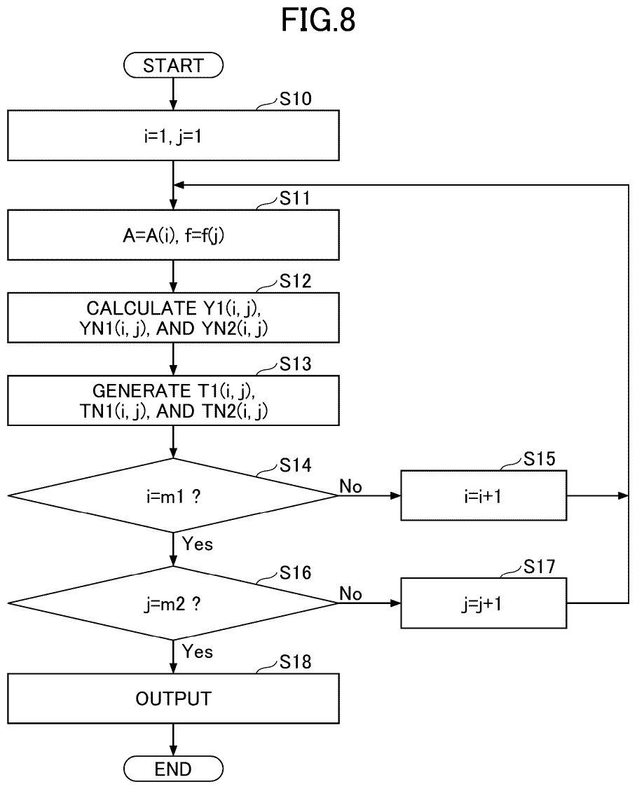

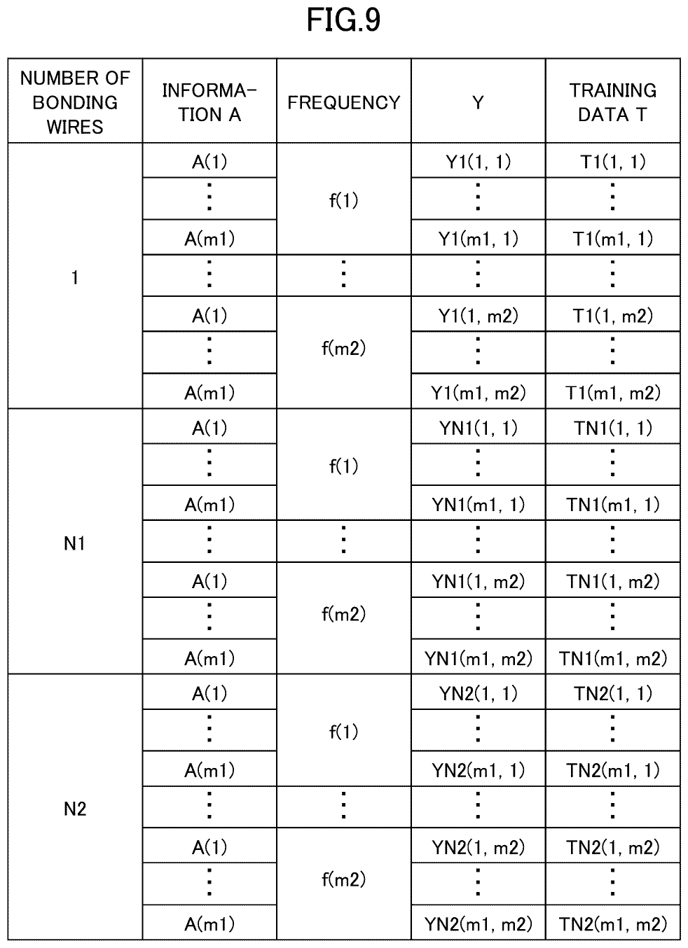

FIG. 8 is a flowchart showing a method of generating training data in the first embodiment. Each step of FIG. 8 may be executed by the computer shown in FIG. 7 or by a human. FIG. 9 is a diagram showing an example of training data in the first embodiment. In FIG. 9, training data T is a set of the number of bonding wires, information A, frequency f, and Y-parameter Y.

As shown in FIG. 8, i and j are both set to one (step S10). Here, i is an integer from one to m1, and j is an integer from one to m2.

Next, information A is set to A(i), and the frequency f is set to f(j) (step S11). A(i) is information on the shape of the bonding wires 10, and includes, for example, the diameter φ1(i), the length W1(i), the height H1(i), and the interval D1(i). Here, i corresponds to one to m1, and thus the value of each information is varied. Further, j corresponds to one to m2, and thus the value of the frequency f(j) is varied.

Next, in the information A(i) and the frequency f(j), simulation (for example, electromagnetic field analysis) is performed for the cases where the number of the bonding wires 10 is one, N1, and N2, and the Y-parameters Y1(i, j), YN1(i, j), and YN2(i, j) are calculated (step S12). The Y-parameters Y1(i, j), YN1(i, j), and YN2(i, j) may be actually measured. Here, each Y-parameter is an admittance matrix of two rows and two columns, and the elements of the admittance matrix are Y11, Y12, Y21, and Y22. Each element is a complex number. The real parts of the respective elements are Re(Y11), Re(Y12), Re(Y21) and Re(Y22). The imaginary parts of the respective elements are Im(Y11), Im(Y12), Im(Y21) and Im(Y22). The Y-parameters Y1(i, j), YN1(i, j), and YN2(i, j) are at least one parameter of Re(Y11), Re(Y12), Re(Y21), Re(Y22), Im(Y11), Im(Y12), Im(Y21), and Im(Y22).

Next, training data T1(i, j), TN1(i, j), and TN2(i, j) are generated (step S13). For example, when i=1 and j=1, the training data T1(1, 1), TN1(1, 1), and TN2(1, 1) each defining the relationship of the information A(1) and the frequency f(1) to Y1(1, 1), YN1(1, 1), and YN2(1, 1), respectively, are generated as in FIG. 9.

Next, it is determined whether i=m1 is satisfied or not (step S14). When the result is “No”, i is set to i+1 in step S15, and the process returns to step S11. By incrementing i from one to m1, m1 pieces of training data T1(i, 1) defining the relationship between the information A(i) and Y1(i, 1) are generated. Then, m1 pieces of training data TN1(i, 1) that define the relationship between the information A(i) and YN1(i, 1) and m1 pieces of training data TN2(i, 1) that define the relationship between the information A(i) and YN2(i, 1) are generated.

When the result is “Yes” in step S14, it is determined whether j=m2 is satisfied or not (step S16). When the result is “No”, j=j+1 is set in step S17, and the process returns to step S11. By incrementing j from one to m2, m1×m2 pieces of training data T1(i, j) defining the relationship between the information A(i) and Y1(i, j) are generated. Thus, m1×m2 pieces of the training data TN1(i, j) that define the relationship between the information A(i) and YN1(i, j) and m1×m2 pieces of the training data TN2(i, j) that define the relationship between the information A(i) and YN2(i, j) are generated.

When the result is “Yes” in step S16, the training data T1, TN1, and TN2 are output to the memory 34 or the external apparatus (step S18). Then, the process is completed.

### (Method of Generating Trained Model)

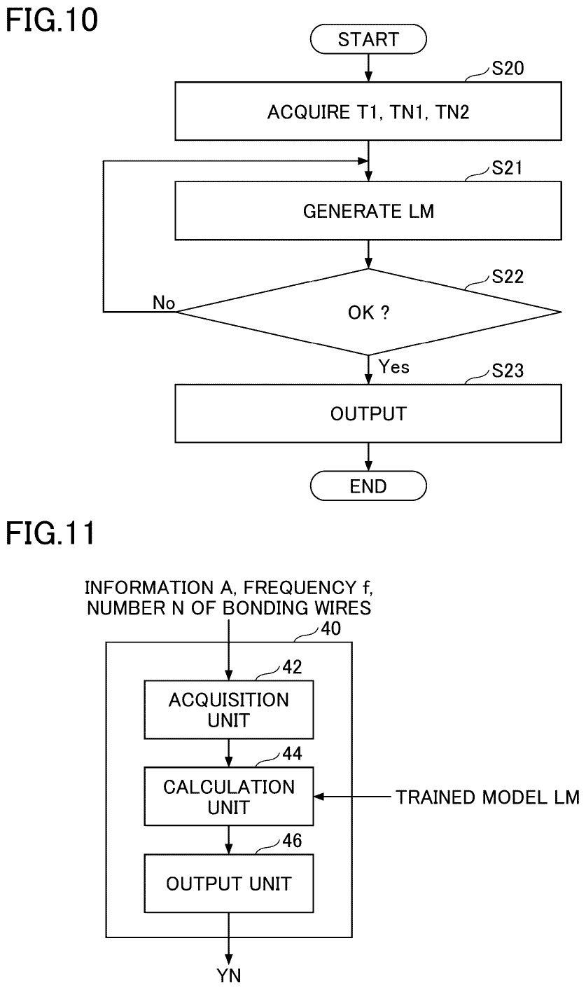

FIG. 10 is a flowchart showing a method of generating a trained model in the first embodiment. As shown in FIG. 10, the processor 32 acquires m1×m2 pieces of training data T1, m1×m2 pieces of training data TN1, and m1×m2 pieces of training data TN2 from the memory 34 or the external apparatus (step S20). The processor 32 performs machine learning based on the acquired training data T1, TN1, and TN2, and generates a trained model LM (step S21). The processor 32 or a human verifies the trained model LM (step S22). For example, Y1, YN1, and YN2 are estimated from the information A, for which the relationships between the information A and Y1, YN1, and YN2 are known, using the trained model LM. When the estimated Y1, YN1, and YN2 substantially match the known Y1, YN1, and YN2, the result is determined as “Yes” in step S22, and when they do not match, the result is determined as “No”. When the result is “No”, the process returns to step S21. When the result is “Yes” in step S22, the trained model LM is output to the memory 34 or the external apparatus (step S23). Here, the machine learning model may be trained to produce outputs that approximate the ground truth Y-parameters for given input data, comprising the numbers of bonding wires, information A, and frequencies f, with the ground truth serving as the supervisory signal.

### (Functional Block Diagram of Calculation Device)

FIG. 11 is a functional block diagram of a calculation device in the first embodiment. As shown in FIG. 11, a calculation device 40 includes an acquisition unit 42, a calculation unit 44, and an output unit 46. The processor 32 functions as the acquisition unit 42, the calculation unit 44, and the output unit 46 in cooperation with the program. The acquisition unit 42 acquires the information A, the frequency f, and the number N of the bonding wires. The calculation unit 44 calculates the Y-parameter YN based on the trained model LM from the acquired information A, the frequency f, and the number N of the bonding wires. The output unit 46 outputs the calculated Y-parameter YN.

### (Method of Calculating Y-Parameter)

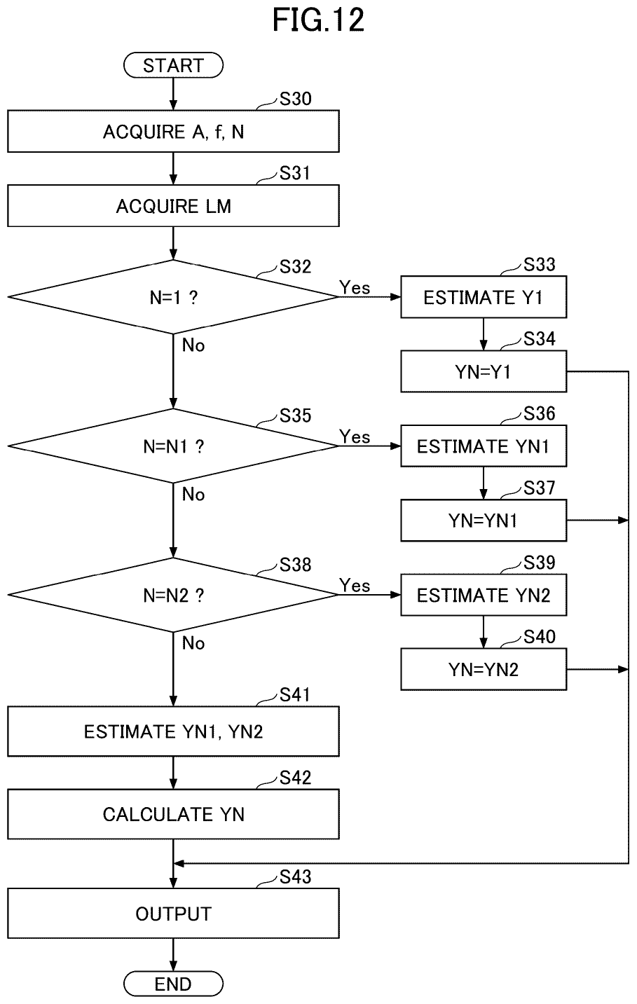

FIG. 12 is a flowchart showing a method of calculating the Y-parameter in the first embodiment. Each step of FIG. 12 is executed by the computer 30. As shown in FIG. 12, the acquisition unit 42 acquires the information A (first information) about the bonding wires 10, information (third information) about the frequency f of the high frequency signal, and information (second information) about the number N of the bonding wires 10 (step S30).

Next, the calculation unit 44 acquires the trained model LM (step S31). The calculation unit 44 determines whether N=1 is satisfied or not (step S32). When the result is “Yes”, the calculation unit 44 estimates Y1 based on the trained model LM from the acquired information A and the frequency f (step S33). Next, the calculation unit 44 sets the estimated Y1 as YN (step S34). Thereafter, the process proceeds to step S43.

When the result is “No” in step S32, the calculation unit 44 determines whether N=N1 is satisfied or not (step S35). When the result is “Yes”, the calculation unit 44 estimates YN1 based on the trained model LM from the acquired information A and the frequency f (step S36). Next, the calculation unit 44 sets the estimated YN1 as YN (step S37). Thereafter, the process proceeds to step S43.

When the result is “No” in step S35, the calculation unit 44 determines whether N=N2 is satisfied or not (step S38). When the result is “Yes”, the calculation unit 44 estimates YN2 based on the trained model LM from the acquired information A and the frequency f (step S39). Next, the calculation unit 44 sets the estimated YN2 as YN (step S40). Thereafter, the process proceeds to step S43.

When the result is “No” in step S38, the calculation unit 44 estimates YN1 and YN2 based on the trained model LM from the acquired information A and the frequency f (step S41). Next, the calculation unit 44 calculates YN from the estimated YN1 and YN2 (step S42). For example, the calculation unit 44 calculates YN by substituting the estimated YN1 and YN2 into Equation 4.

Thereafter, the output unit 46 outputs the Y-parameter YN to the memory 34 or the external apparatus (step S43). Then, the process is completed. The order of steps S32 to S34, S35 to S37, and S38 to S40 can be set as appropriate.

### First Comparative Example

As a first comparative example, an example of modeling bonding wires using a neural network will be described. The explanatory variables and the objective variables of the neural network are as follows.

### Explanatory Variables

The diameter φ1, the length W1, the height H1, the interval D1, the number N of the bonding wires, the frequency f

### Objective Variables

Re(S11), Re(S12), Re(S21), Re(S22), Im(S11), Im(S12), Im(S21), Im(S22)
S11, S12, S21, and S22 are S-parameters between the first port P1 and the second port P2.
   In the first comparative example, training data corresponding to the number N of the bonding wires is created. Thus, the training data becomes enormous. In addition, the trained model based on a neural network becomes large.

### Description of First Embodiment

Examples of the explanatory variables and the objective variables of the neural network in the first embodiment are as follows.

### Explanatory Variables

The diameter φ1, the length W1, the height H1, the interval D1, the frequency f

### Objective Variables

Re(Y1_11), Re(Y1_12), Re(Y1_Y21), Re(Y1_Y22), Im(Y1_11), Im(Y1_12), Im(Y1_21), Im(Y1_22)
Re(YN1_11), Re(YN1_12), Re(YN1_Y21), Re(YN1_Y22), Im(YN1_11), Im(YN1_12), Im(YN1_21), Im(YN1_22)
Re(YN2_11), Re(YN2_12), Re(YN2_Y21), Re(YN2_Y22), Im(YN2_11), Im(YN2_12), Im(YN2_21), Im(YN1_22)
   In the first embodiment, the number of objective variables is three times that of the first comparative example, but the number N of the bonding wires may be three types of one, N1, and N2. Thus, the training data can be reduced as compared with the first comparative example. In addition, the trained model based on the neural network can be reduced. Note that the objective variables may be at least one parameter of the eight Y-parameters in each of Y1, YN1, and YN2.

According to the program, method and calculation device of the first embodiment, as in FIGS. 8 and 9, training data T each defines the relationship of the information A(i) (first information) and the number N of the bonding wires to the Y-parameters Y1, YN1 and YN2 obtained for the information A(i) and the number N, when the number N is one, N1, and N2.

As in FIG. 10, the trained model LN is generated by performing machine learning on the training data T. As in step S30 of FIG. 12, the acquisition unit 42 acquires the information A other than the number of the bonding wires 10 and second information about the number N of the bonding wires 10. As in steps S32 to S42, the calculation unit 44 estimates, based on the trained model LM from the information A, the Y-parameter Y1 (first parameter) when the number N is one, the Y-parameter YN1 (second parameter) when the number N is N1, and Y-parameter YN2 (third parameter) when the number N is N2. The calculation unit 44 calculates the Y-parameter YN (calculation parameter) for the number N indicated by the second information, based on at least one parameter of Y1, YN1, and YN2 from the second information indicating the number N. Thus, compared to the first comparative embodiment, the training data can be reduced, the trained model can be reduced, and even when the load on the computer is small, the Y-parameter of the bonding wires 10 can be calculated with high accuracy. Further, each of the Y-parameters Y1, YN1, YN2, and YN to be calculated may be all of the eight parameters, or may be at least one parameter of the eight parameters.

As in steps S41 and S42, the calculation unit 44 calculates YN based on YN1 and YN2 when number N of the bonding wires 10 differs from one, N1, and N2. Thus, when the number N differs from one, N1, and N2, YN can be calculated with high accuracy using, for example, Equation 4.

As in steps S34, S37, and S40, the calculation unit 44 calculates Y1 as YN when the number N the bonding wires 10 is one, calculates YN1 as YN when the number N is N1, and calculates YN2 as YN when the number N is N2. Thus, when the number N of the bonding wires 10 is one, N1 or N2, YN can be calculated with high accuracy.

As in FIGS. 8 to 10, the trained model LM is one trained model generated by performing machine learning on a plurality of pieces of training data T defining relationships of the information A and the number N of the bonding wires 10 to a plurality of YNs obtained for the information A and the number N. As in step S41 of FIG. 12, when the number N differs from one, N1, and N2, the calculation unit 44 estimates YN1 based on the trained model LM from the information A and N1 as the number N, and estimates YN2 based on the trained model LM from the information A and N2 as the number N. In step S42, YN is calculated based on YN1 and YN2. Thus, YN can be calculated using one trained model LN.

As in steps S33 and S34, when the number N of the bonding wires 10 is one, the calculation unit 44 estimates Y1 based on the trained model LM from the information A and one as the number N, and calculates Y1 as YN. As in steps S36 and S37, when the number N of the bonding wires 10 is N1, the calculation unit 44 estimates YN1 based on the trained model LM from the information A and N1 as the number N, and calculates YN1 as YN. As in steps S39 and S40, when the number N of the bonding wires 10 is N2, the calculation unit 44 estimates YN2 based on the trained model LN from the information A and N2 as the number N, and calculates YN2 as YN. Thus, YN can be calculated using one trained model LN.

When the bonding wires 10 includes at least three bonding wires 10, the intervals D1 between adjacent bonding wires of the at least three bonding wires 10 are constant. Thus, the Y-parameter YN can be approximated by Equation 3, and thus the Y-parameter of the bonding wires 10 can be calculated with high accuracy. The interval D1 being constant is not limited to the interval D1 being exactly equal. For example, when the maximum value of the plurality of intervals D1 is MAX and the minimum value is MIN, 2×(MAX−MIN)/(MAX+MIN)≤0.1 may suffice.

As in FIGS. 8 to 10, the trained model LN is generated by performing machine learning on training data T defining the relationships of the information A, the frequency f, and the number N of the bonding wires 10 to a plurality of Y-parameters obtained for the information A, the frequency f, and the number N. As in step S30 in FIG. 12, the acquisition unit 42 acquires the third information about the frequency f of a high frequency signal transmitted between the first port P1 and the second port P2. As in steps S33, S36, S39 and S41, the calculation unit 44 estimates Y1, YN1 or YN2 based on the trained model LM from the information f and the third information. As in steps S34, S37, S40 and S42, the calculation unit 44 calculates, from the number N, YN for the number N based on the at least one of Y1, YN1 or YN2. Thus, the Y-parameter YN at any frequency can be calculated.

### First Modification of First Embodiment

A first modification of the first embodiment is an example in which a plurality of trained models are used.

### (Method of Generating Trained Model)

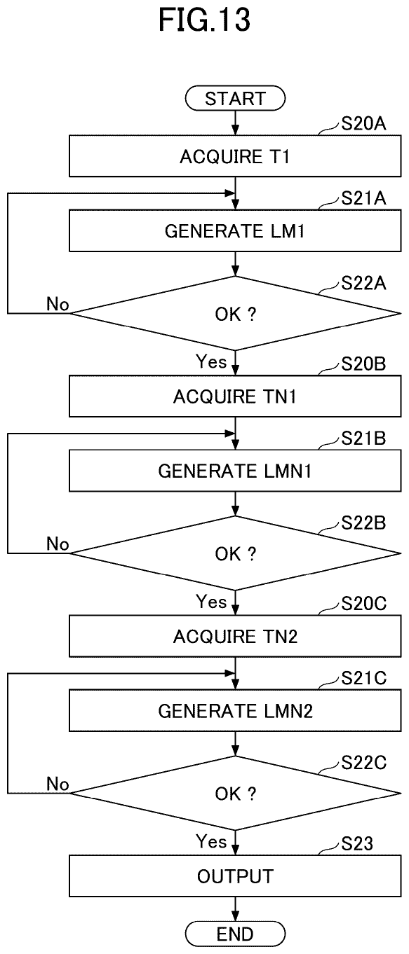

FIG. 13 is a flowchart showing a method of generating a trained model in the first modification of the first embodiment. As shown in FIG. 13, the processor 32 acquires m1×m2 pieces of training data T1 from the memory 34 or the external apparatus (step S20A). The processor 32 performs machine learning based on the acquired training data T1 and generates a trained model LM1 (step S21A). The processor 32 or a human verifies the trained model LM1 (step S22A). When the result is “No”, the process returns to step S21A.

When the result is “Yes” in step S22A, the processor 32 acquires m1×m2 pieces of training data TN1 from the memory 34 or the external apparatus (step S20B). The processor 32 performs machine learning based on the acquired training data TN1 and generates a trained model LMN1 (step S21B). The processor 32 or a human verifies the trained model LMN1 (step S22B). When the result is “No”, the process returns to step S21B.

When the result is “Yes” in step S22B, the processor 32 acquires m1×m2 pieces of training data TN2 from the memory 34 or the external apparatus (step S20C). The processor 32 performs machine learning based on the acquired training data TN2 and generates a trained model LMN2 (step S21C). The processor 32 or a human verifies the trained model LMN2 (step S22C). When the result is “No”, the process returns to step S21C. When the result is “Yes” in step S22C, the trained models LM1, LMN1, and LMN2 are output to the memory 34 or the external apparatus (step S23). Thereafter, the process is completed. The order of steps S20A to S22A, S20B to S22B, and S20C to S22C can be set as appropriate. Further, the training data T1, TN1, and TN2 may be acquired in step S20A, and steps S20B and S20C do not have to be performed.

### (Method of Calculating Y-Parameter)

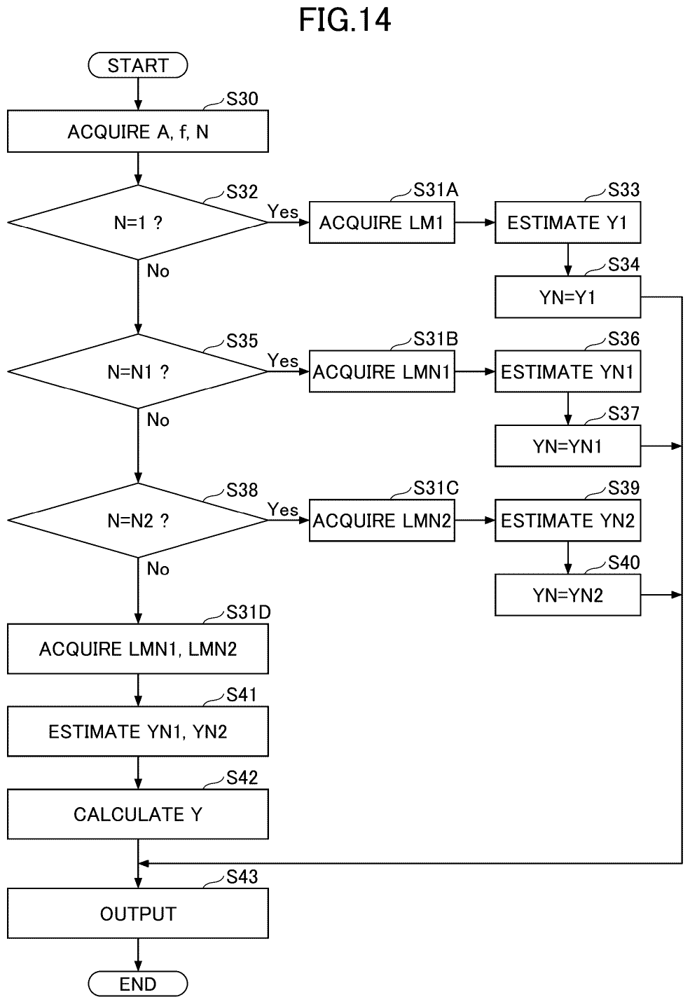

FIG. 14 is a flowchart showing a method of calculating the Y-parameter in the first modification of the first embodiment. As shown in FIG. 14, the calculation unit 44 does not acquire the trained model between steps S30 and S32. When the result is “Yes” in step S32, the calculation unit 44 acquires the trained model LM1 (step S31A). Next, the calculation unit 44 estimates Y1 based on the trained model LM1 from the acquired information A and the frequency f (step S33). The calculation unit 44 sets the estimated Y1 as YN (step S34). Thereafter, the process proceeds to step S43.

When the result is “Yes” in step S35, the calculation unit 44 acquires the trained model LMN1 (step S31B). Next, the calculation unit 44 estimates YN1 based on the trained model LMN1 from the acquired information A and the frequency f (step S36). Next, the calculation unit 44 sets the estimated YN1 as YN (step S37). Thereafter, the process proceeds to step S43.

When the result is “Yes” in step S37, the calculation unit 44 acquires the trained model LMN2 (step S30C). Next, the calculation unit 44 estimates YN2 based on the trained model LMN2 from the acquired information A and the frequency f (step S39). Next, the calculation unit 44 sets the estimated YN2 as YN (step S40). Thereafter, the process proceeds to step S43.

When the result is No in step S38, the calculation unit 44 acquires the trained models LMN1 and LMN2 (step S30D). Next, the calculation unit 44 estimates YN1 based on the trained model LM1 from the acquired information A and the frequency f, and estimates YN2 based on a trained model LM2 from the acquired information A and the frequency f (step S41). Next, the calculation unit 44 calculates YN from the estimated YN1 and YN2 (step S42). The other flow is the same as that of FIG. 12, and the description thereof is omitted. The trained models LM1, LMN1, and LMN2 may be acquired between steps S30 and S32, and steps S31A to S31D do not have to be performed.

In the first modification of the first embodiment, there are three trained models LM1, LMN1, and LMN2 based on the neural network. Examples of the explanatory variables and the objective variables in each model are as follows.

### Trained Model LM1

### Explanatory Variables

The diameter φ1, the length W1, the height H1, the interval D1, the frequency f

### Objective Variables

Re(Y1_11), Re(Y1_12), Re(Y1_Y21), Re(Y1_Y22), Im(Y1_11), Im(Y1_12), Im(Y1_21), Im(Y1_22)

### Trained Model LMN1

### Explanatory Variables

The diameter φ1, the length W1, the height H1, the interval D1, the frequency f

### Objective Variables

Re(YN1_11), Re(YN1_12), Re(YN1_Y21), Re(YN1_Y22), Im(YN1_11), Im(YN1_12), Im(YN1_21), Im(YN1_22)

### Trained Model LMN1

### Explanatory Variables

The diameter φ1, the length W1, the height H1, the interval D1, the frequency f

### Objective Variables

Re(YN2_11), Re(YN2_12), Re(YN2_Y21), Re(YN2_Y22), Im(YN2_11), Im(YN2_12), Im(YN2_21), Im(YN1_22)

According to the first modification of the first embodiment, the trained model includes LM1 (first trained model), LMN1 (second trained model), and LMN2 (third trained model). As in FIGS. 9 and 14, LM1 is generated by performing machine learning on training data T1 (first training data) defining a relationship between the information A and Y1 obtained for the information A when the number N is one. LMN1 is generated by performing machine learning on training data TN1 (second training data) defining a relationship between the information A and YN1 obtained for the information A when the number N is N1. LMN2 is generated by performing machine learning on training data TN2 (third training data) defining a relationship between the information A and YN2 obtained for the information A when the number N is N2. This increases the number of trained models, but can reduce the amount of data per trained model. Thus, the load on the computer 30 can be reduced.

As in steps S31D and S41, when the number N differs from one, N1, and N2, the calculation unit 44 estimates YN1 based on the trained model LMN1 from the information A, and estimates YN2 based on the trained model LMN2 from the information A. As in step S42, the calculation unit 44 calculates YN based on the estimated YN1 and YN2. Thus, YN can be calculated with high accuracy.

As in steps S31A, S33, and S34, when the number N is one, the calculation unit 44 estimates Y1 based on the trained model LM1 from the information A, and calculates Y1 as YN. As in steps S31B, S36, and S37, when the number N is N1, the calculation unit 44 estimates YN1 based on the trained model LMN1 from the information A, and calculates YN1 as YN. As in steps S31C, S39, and S40, when the number N is N2, the calculation unit 44 estimates YN2 based on the trained model LMN2 from the information A, and calculates YN2 as YN. Thus, YN can be calculated with high accuracy.

### Second Embodiment

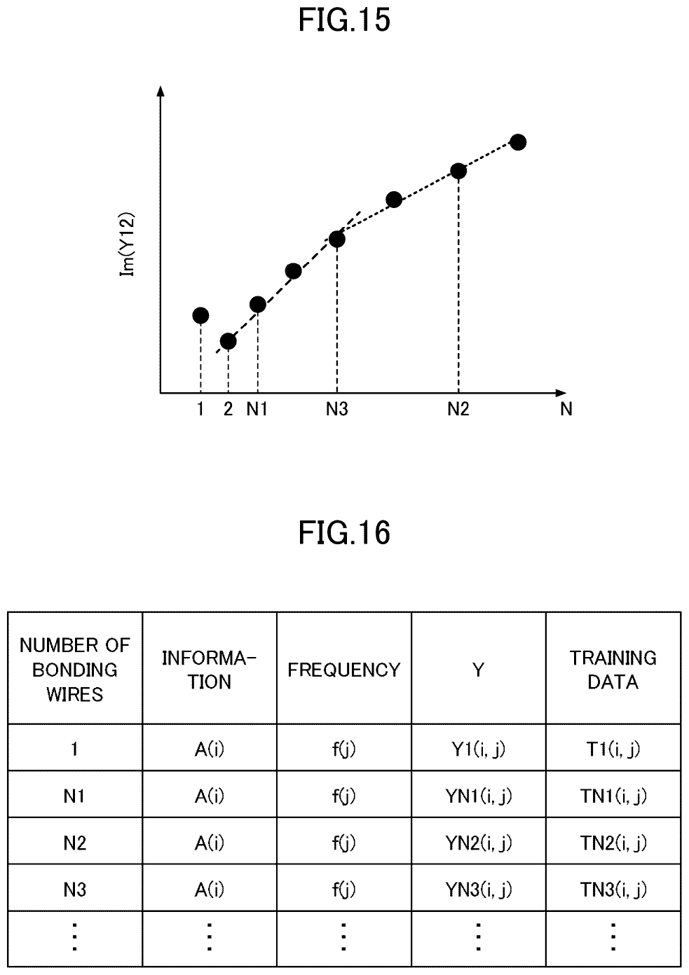

A second embodiment is an example in which the number N of the bonding wires used for the training data is set to four or more. FIG. 15 is a schematic diagram showing Im(Y12) with respect to the number N of the bonding wires in the second embodiment. As shown in FIG. 15, when the number N is 2 or more, Im(Y12) deviates from a straight line with respect to N. Thus, in the second embodiment, a Y-parameter YN3 is estimated when the number N is N3 between N1 and N2.

### (Training Data)

FIG. 16 is a diagram showing an example of training data in the second embodiment. In FIG. 16, for the sake of simplicity, A(1) to A(m1) in FIG. 9 are represented by A(i), and f(1) to f(m2) in FIG. 9 are represented by f(j). Y1(1, 1) to Y1(m1, m2) in FIG. 9 are represented by Y1(i, j), and T1(1, 1) to T1(m1, m2) in FIG. 9 are represented by T1(i, j). The same applies to YN1(i, j), TN1(i, j), YN2(i, j), TN2(i, j), YN3(i, j), and T3(i, j). As in FIG. 16, in the second embodiment, TN3(i, j) is used as training data in addition to T1(i, j), TN1(i, j), and TN2(i, j).

### (Method of Calculating Y-Parameter)

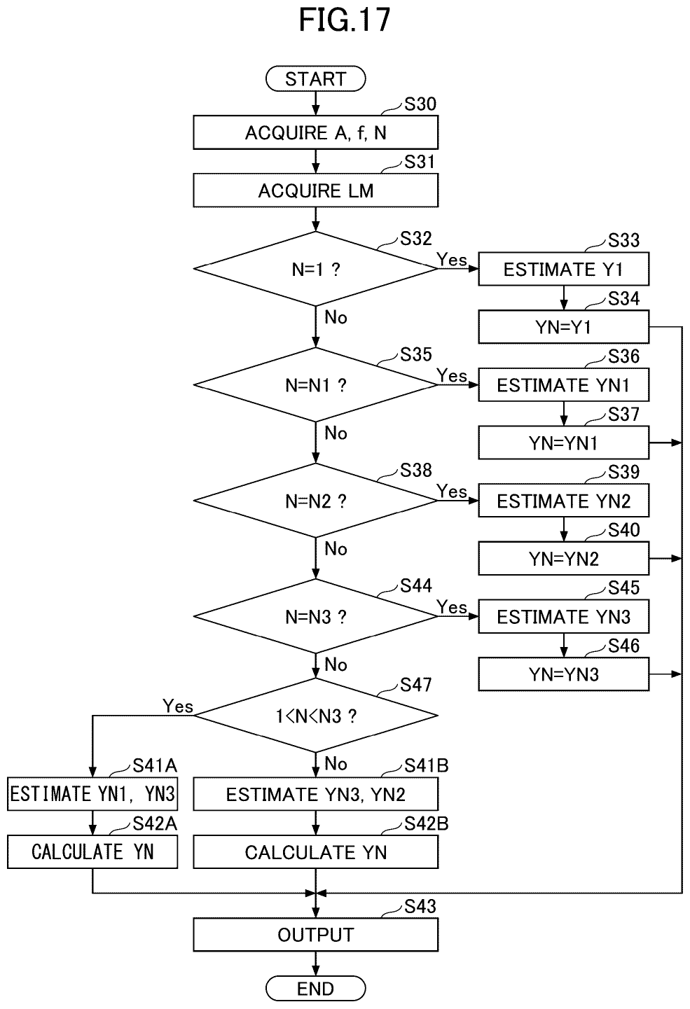

FIG. 17 is a flowchart showing a method of calculating the Y-parameter in the second embodiment. As shown in FIG. 17, when the result is “No” in step S38, the calculation unit 44 determines whether N=N3 is satisfied or not (step S44). When the result is “Yes”, the calculation unit 44 estimates YN3 based on the trained model LM from the acquired information A and the frequency f (step S45). Next, the calculation unit 44 sets the estimated YN3 as YN (step S46). Thereafter, the process proceeds to step S43.

When the result is “No” in step S44, the calculation unit 44 determines whether 1<N<N3 is satisfied or not (step S47). When the result is “Yes”, the calculation unit 44 estimates YN1 and YN3 based on the trained model LM from the acquired information A and the frequency f (step S41A). The calculation unit 44 calculates YN from the estimated YN1 and YN3 (step S42A). Thereafter, the process proceeds to step S43.

When the result is “No” in step S47, the calculation unit 44 estimates YN3 and YN2 based on the trained model LM from the acquired information A and the frequency f (step S41B). The calculation unit 44 calculates YN from the estimated YN3 and YN2 (step S42A). Thereafter, the process proceeds to step S43. The order of steps S32 to S34, S35 to S37, S38 to S40, and S44 to S46 can be set as appropriate. The other flow is the same as that of FIG. 12, and the description thereof is omitted.

Equation 5 for calculating YN in steps S42A and S42B is as follows.

$$YN = ( N - 1 ) \times ( YB - YA ) / ( NB - NA ) - ( ( NA - 1 ) \times YB - ( NB - 1 ) \times YA ) / ( NB - NA ) \qquad ( Equation 5 )$$

Here, in step S42A, NA=N1, NB=N3, YA=YN1, and YB=YN3 are satisfied. In step S42B, NA=N3, NB=N2, YA=YN3, and YB=YN2 are satisfied.

According to the second embodiment, as in FIG. 16, the trained model LM is generated by performing machine learning on a plurality of training data TN3 defining relationships of the information A and the number N3 to a plurality of YN3 obtained for the information A and number N3 when the number N is N3, in addition to the training data T1, TN1, and TN2 of FIG. 9 of the first embodiment. As in steps S41A and S42A of FIG. 17, when the number N is less than N3, the calculation unit 44 estimates YN1 and YN3 (fourth parameter) based on the trained model LM, and calculates YN based on YN1 and YN3. As in steps S41B and S42B, when the number N is more than N3, the calculation unit 44 estimates YN3 and YN2 based on the trained model LM, and calculates YN based on YN3 and YN2. Thus, even when the inclination of YN with respect to the number N changes depending on N, the Y-parameter of the bonding wires 10 can be calculated with high accuracy.

The number of the numbers N for estimating the Y-parameter may be five or more. For example, the trained model is generated using the training data generated when the number is one, two, N1, N3, and N2. When the number N for calculating the Y-parameter satisfies 2<N<N1, Y2 and YN1 are estimated, and YN is calculated from Y2 and YN1 using Equation 5. When the number N satisfies N1<N<N3, YN1 and YN3 are estimated, and YN is calculated from YN1 and YN3 using Equation 5. When the number N satisfies N3<N, YN3 and YN2 are estimated, and YN is calculated from YN3 and YN2 using Equation 5.

The trained model may include four trained models when the number N is one, N1, N3, and N2, as in the first modification of the first embodiment.

### Third Embodiment

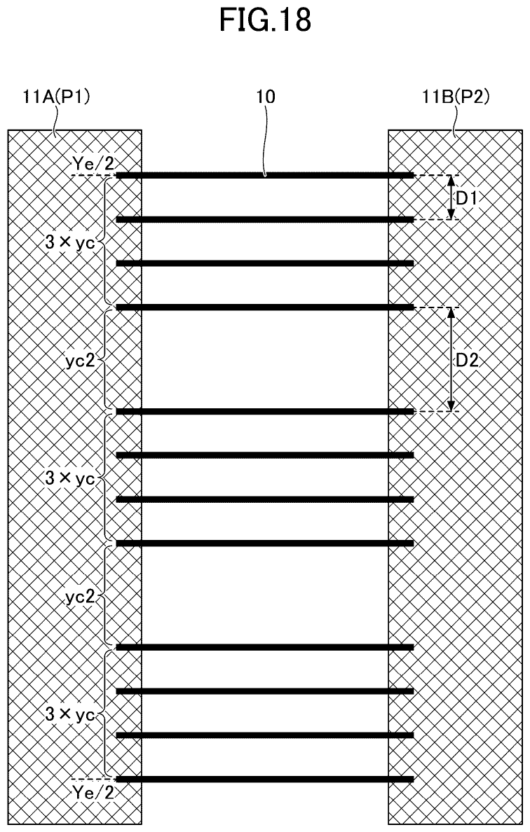

A third embodiment is an example in which the intervals of the bonding wires 10 are different. FIG. 18 is a schematic diagram of a bonding wire for estimating circuit parameters in the third embodiment. As shown in FIG. 18, the bonding wires 10 connected side by side between the pads 11A and 11B have two levels of intervals D1 and D2 between adjacent bonding wires 10. When the number of intervals D1 is n and the number of intervals D2 is m, the number N of the bonding wires 10 satisfies N=n+m+1. In the example of FIG. 18, n=9, m=2, and N=12.

A Y-parameter Ynm between the first port P1 and the second port P2 satisfies Ynm=Ye+9×yc+2×yc2. More generally, Ynm is expressed by Equation 6.

$$Ynm = ye + n \times yc + m \times yc 2 \qquad ( Equation 6 )$$

When Yn=ye+n×yc and Ym=m×yc2 are satisfied, Ynm is expressed by Equation 7.

$$Ynm = Yn + Ym \qquad ( Equation 7 )$$

Here, ye and yc are the same as in Equation 1. Thus, when the number N of the bonding wires 10 is set to n+1 in FIG. 1A, Yn is expressed by Equation 8.

$$Yn = n \times ( YN 2 - YN 1 ) / ( N 2 - N 1 ) - ( N 1 - 1 ) \times YN 2 - ( N 2 - 1 ) \times YN 1 ) / ( N 2 - N 1 ) \qquad ( Equation 8 )$$

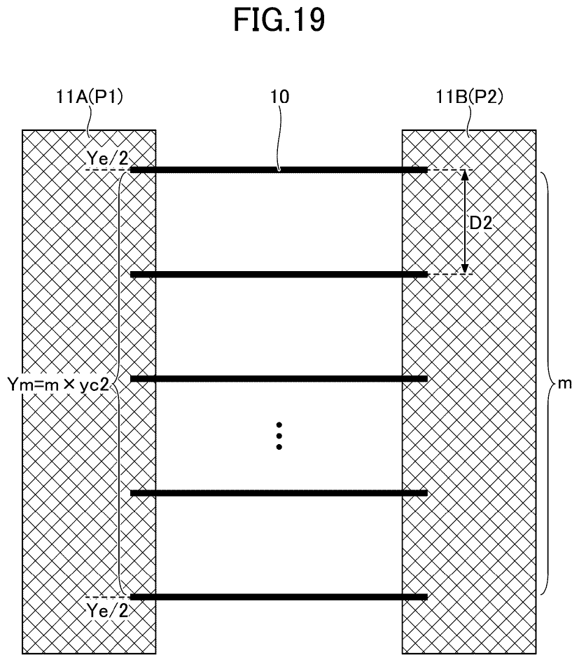

FIG. 19 is a schematic view of a bonding wire. As shown in FIG. 19, m+1 bonding wires 10 are connected between the pads 11A and 11B. The interval D2 between adjacent bonding wires 10 is constant. The number of the intervals D2 is m. Ym excluding ye/2 at both ends is m×yc2. Thus, M1 and M2, which are any numbers different from each other, are set as the numbers m of the intervals. The Y-parameters between the first port P1 and the second port P2 for the numbers of the intervals M1 and M2 are YM1 and YM2, respectively. At this time, Ym can be calculated from Equation 9.

$$Ym = m \times ( YM 2 - YM 2 ) / ( M 2 - M 1 ) \qquad ( Equation 9 )$$

### (Training Data)

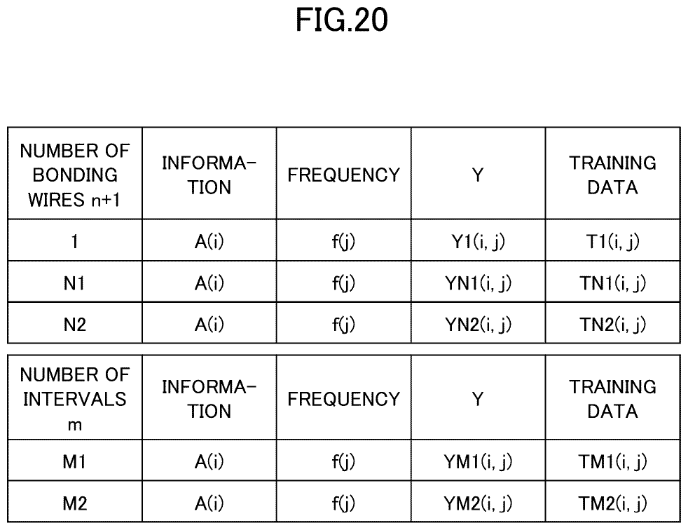

FIG. 20 is a diagram showing an example of training data in the third embodiment. As in FIG. 20, the training data T1(i, j), TN1(i, j) and TN2(i, j) are generated in the same manner as in FIG. 9. The training data T1(i, j), TN1(i, j) and TN2(i, j) are generated using samples each having the constant interval D1 between adjacent bonding wires 10 as in FIG. 1A. The number of the bonding wires 10 corresponds to n+1.

Further, when the number m of the intervals D2 is M1, training data TM1(i, j) is generated in which the information A(j) and the frequency f(j) are associated with YM1(i, j) simulated from the information A(j) and the frequency f(j). When the number m of the intervals D2 is M2, training data TM2(i, j) is generated in which the information A(j) and the frequency f(j) are associated with YM2(i, j) simulated from the information A(j) and the frequency f(j).

### (Method of Generating Trained Model)

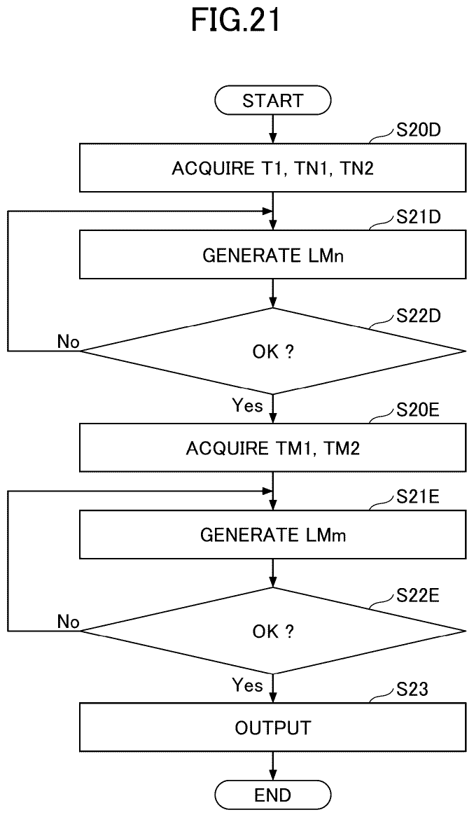

FIG. 21 is a flowchart showing a method of generating a trained model in the third embodiment. As shown in FIG. 21, the processor 32 acquires training data T1, TN1, and TN2 from the memory 34 or the external apparatus (step S20D). The processor 32 performs machine learning based on the acquired training data T1, TN1, and TN2, and generates a trained model LMn (step S21D). The processor 32 or a human verifies the trained model LMn (step S22D). When the result is No, the process returns to step S21D.

When the result is “Yes” in step S22D, the processor 32 acquires the training data TM1 and TM2 from the memory 34 or the external apparatus (step S20E). The processor 32 performs machine learning based on the acquired training data TM1 and TM2, and generates a trained model LMm (step S21E). The processor 32 or the human verifies the trained model LMm (step S22E). When the result is “No”, the process returns to step S21E. When the result is “Yes” in step S22E, the trained models LMn and LMm are output to the memory 34 or the external apparatus (step S23). Thereafter, the process is completed. The order of steps S20D to S22D and S20E to S22E can be set as appropriate. The training data TM1 and TM2 may be acquired in step S20D, and step S20E does not have to be performed.

### (Method of Calculating Y-Parameter)

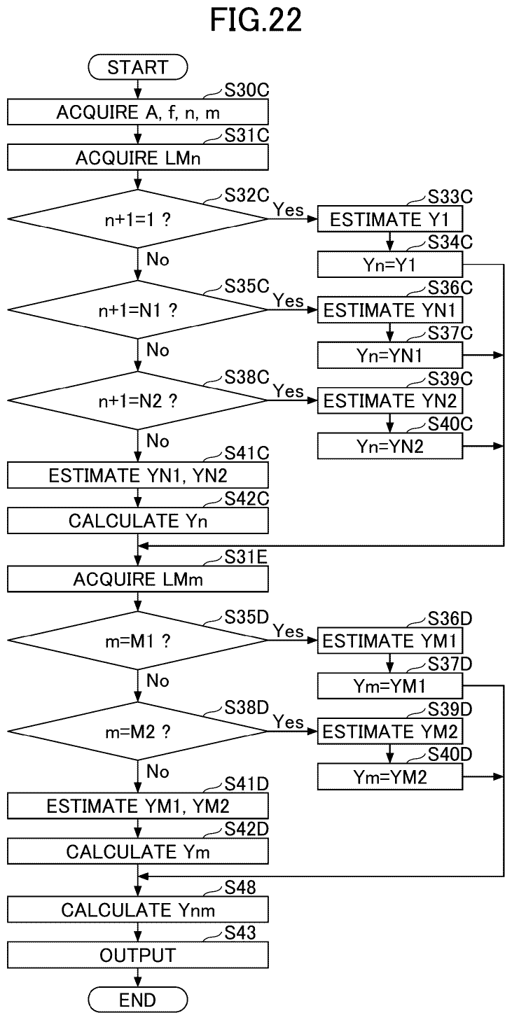

FIG. 22 is a flowchart showing a method of calculating a Y-parameter in the third embodiment. As shown in FIG. 22, the acquisition unit 42 acquires the information A about the bonding wires 10, information about the frequency f, the number n of the intervals D1, and the number m of the intervals D2 (step S30C).

Next, the calculation unit 44 acquires the trained model LMn (step S31C). The calculation unit 44 determines whether n+1=1 is satisfied or not (step S32C). When the result is “Yes”, the calculation unit 44 estimates Y1 based on the trained model LMn from the acquired information A and the frequency f (step S33C). Next, the calculation unit 44 sets the estimated Y1 as Yn (step S34C). Thereafter, the process proceeds to step S31E.

When the result is “No” in step S32C, the calculation unit 44 determines whether n+1=N1 is satisfied or not (step S35C). When the result is “Yes”, the calculation unit 44 estimates YN1 based on the trained model LMn from the acquired information A and the frequency f (step S36S). Next, the calculation unit 44 sets the estimated YN1 as Yn (step S37C). Thereafter, the process proceeds to step S31E.

When the result is “No” in step S35C, the calculation unit 44 determines whether n+1=N2 is satisfied or not (step S38C). When the result is “Yes”, the calculation unit 44 estimates YN2 based on the trained model LMn from the acquired information A and the frequency f (step S39D). Next, the calculation unit 44 sets the estimated YN2 as Yn (step S40C). Thereafter, the process proceeds to step S31E.

When the result is “No” in step S38C, the calculation unit 44 estimates YN1 and YN2 based on the trained model LMn from the acquired information A and the frequency f (step S41C). Next, the calculation unit 44 calculates Yn from the estimated YN1 and YN2 (step S42C). For example, the calculation unit 44 calculates Yn from YN1 and YN2 using Equation 8.

Thereafter, the calculation unit 44 acquires a trained model LMm (step S31E). The calculation unit 44 determines whether m=M1 is satisfied or not (step S35D). When the result is “Yes”, the calculation unit 44 estimates YM1 based on the trained model LMm from the acquired information A and the frequency f (step S36D). Next, the calculation unit 44 sets the estimated YM1 as Ym (step S37D). Thereafter, the process proceeds to step S48.

When the result is “No” in step S35D, the calculation unit 44 determines whether m=M2 is satisfied or not (step S38D). When the result is “Yes”, the calculation unit 44 estimates YM2 based on the trained model LMm from the acquired information A and the frequency f (step S39D). Next, the calculation unit 44 sets the estimated YM2 as Ym (step S40D). Thereafter, the process proceeds to step S48.

When the result is “No” in step S38D, the calculation unit 44 estimates YM1 and YM2 based on the trained model LMm from the acquired information A and the frequency f (step S41D). Next, the calculation unit 44 calculates Ym from the estimated YM1 and YM2 (step S42D). For example, the calculation unit 44 calculates Ym from YM1 and YM2 using Equation 9.

Next, the calculation unit 44 calculates Ynm from the calculated Yn and Ym (step S48). For example, the calculation unit 44 calculates Ynm from Yn and Ym using Equation 7. Thereafter, the output unit 46 outputs the Y-parameter Ynm to the memory 34 or the external apparatus (step S43). Then, the process is completed. The order of steps S32C to S34C, S35C to S37C, and S38C to S40C can be set as appropriate. The order of S35D to S37D and S38D to S40D can be set as appropriate. The trained model LMm may be acquired in step S31C, and step S31E does not have to be performed.

According to the third embodiment, for at least three bonding wires 10 connected side by side between the first port P1 and the second port P2, the intervals between adjacent bonding wires 10 have D1 (first interval) and D2 (second interval different from the first interval). The number of the intervals D1 is n (first number), and the number of the intervals D2 is m (second number). The number n of the intervals D1 is N−1 using the number N of the bonding wires 10 in the first embodiment. That is, in the first embodiment, the N1 corresponds to a case where the number n of the intervals is N1−1, and the N2 corresponds to a case where the number n of the intervals is N2−1.

As in FIGS. 19 and 20, LMn and LMm are generated as trained models. The trained model LMn is generated by performing machine learning on the plurality of training data T1, TN1, and TN2 defining relationships of the information A and the number n+1 of the bonding wires to the Y-parameters Y1, YN1, and YN2 obtained for the information A and the number n+1 of the bonding wires when the number n+1 of the bonding wires is one, N1, and N2.

The trained model LMm is generated by performing machine learning on the plurality of training data TM1 and TM2 defining relationships of the information A and the number m of the intervals to the Y-parameters YM1 and YM2 obtained for the information A and the number m of the intervals when the number m of the intervals is M1 and M2.

As in steps S33C, S36C, S39C and S41C of FIG. 22, the calculation unit 44 estimates at least one of Y1, YN1 or YN2 based on the trained model LMn. As in steps S36D, S39D and S41D, the calculation unit 44 estimates at least one of YM1 (fourth parameter) or YM2 (fifth parameter) based on another trained model LMm. As in steps S34C, S37C, S40C, S42C, S37D, S40D, S42D, and S48, the calculation unit 44 calculates Ynm (calculation parameter) for the number n of the intervals and the number m of the intervals indicated by the second information, based on at least one of Y1, YN1, YN2, YM1, or YM2. Thus, Ynm can be calculated with high accuracy in the case where the intervals between the bonding wires 10 are at two levels, D1 and D2.

The trained model LMn may include three trained models generated when the number n of intervals is zero, N1−1, and N2−1. The trained model LMm may include two trained models corresponding to the number m of the intervals being M1 and M2.

In the first embodiment to the third embodiment, the Y-parameter is described as an example of the circuit parameter. The circuit parameter is a parameter represented by a matrix of the first port P1 and the second port P2. The circuit parameter may be, for example, an S-parameter (scattering matrix) or a Z-parameter (impedance matrix). The circuit parameter may be a parameter that can be uniquely calculated from the Y-parameter.

Y-parameters provided in parallel can be added for calculation. Thus, the processes of step S42 in FIGS. 12 and 14, steps S42A and S42B in FIG. 17, and steps S42C and S42D in FIG. 22 is performed using the Y-parameter. At least a part of the other processes may use a parameter (for example, an S-parameter or a Z-parameter) that can be uniquely calculated from the Y-parameter.

When the number of bonding wires 10 is large, it is difficult to calculate the circuit parameter with high accuracy. From this viewpoint, when the number of bonding wires 10 is 10 or more or 50 or more, the first embodiment to the third embodiment can be used.

Each process (each function) of the above-described embodiments is implemented by a circuitry including one or more processors. The circuitry may be configured by an integrated circuit or the like in which one or more memories, various analog circuits, and various digital circuits are combined in addition to the one or more processors. The one or more memories store a program (command) for causing the one or more processors to execute the processes. The one or more processors may execute the processes in accordance with the program read from the one or more memories, or may execute the processes in accordance with a logic circuit designed in advance to execute the processes.

The processor may be any of various processors suitable for control of a computer, such as a CPU, a graphics processing unit (GPU), a digital signal processor (DSP), a field programmable gate array (FPGA), and an application specification integrated circuit (ASIC). A plurality of processors physically separated from each other may execute the processes in cooperation with each other. For example, the processors mounted on a plurality of physically separated computers may execute the processes in cooperation with each other via a network such as a local area network (LAN), a wide area network (WAN), or the Internet.

The program may be installed in the memory from an external server device or the like via the network, or may be distributed in a state of being stored in a recording medium such as a CD-ROM, a DVD-ROM, or a semiconductor memory and installed in the memory from the recording medium.

The embodiments disclosed herein are to be considered as illustrative and non-restrictive in all respects. The scope of the present disclosure is defined by the claims, not in the sense described above, and is intended to include all modifications within the scope and meaning equivalent to the scope of the claims.

What is claimed is:

1. A non-transitory computer-readable recording medium having stored therein a program for causing a computer to execute a process, the process comprising:
acquiring first information about one or more bonding wires other than a number of the one or more bonding wires, and second information about the number of the one or more bonding wires, the one or more bonding wires being connected side by side between a first port and a second port;
estimating, from the first information based on a trained model, at least one parameter of a first parameter that is a circuit parameter between the first port and the second port when the number of the bonding wires is one, a second parameter that is the circuit parameter when the number of the bonding wires is N1 that is two or more, or a third parameter that is the circuit parameter when the number of the bonding wires is N2 that is more than N1; and
calculating a calculation parameter that is the circuit parameter for the number of the one or more bonding wires indicated by the second information, based on the at least one parameter from the second information,
wherein the trained model is generated by performing machine learning on training data, the training data each defining a relationship of the first information and the number of the one or more bonding wires to the circuit parameter obtained for the first information and the number of the one or more bonding wires when the number of the one or more bonding wires is one, N1, and N2.

2. The non-transitory computer-readable storage medium according to claim 1, wherein, when the number of the one or more bonding wires indicated by the second information differs from one, N1, and N2, the calculating calculates the calculation parameter based on the second parameter and the third parameter.

3. The non-transitory computer-readable storage medium according to claim 2,
wherein, when the number of the one or more bonding wires indicated by the second information is one, the first parameter is calculated as the calculation parameter,
wherein, when the number of the one or more bonding wires indicated by the second information is N1, the second parameter is calculated as the calculation parameter, and
wherein, when the number of the one or more bonding wires indicated by the second information is N2, the third parameter is calculated as the calculation parameter.

4. The non-transitory computer-readable storage medium according to claim 1,
wherein the trained model includes:
a first trained model generated by performing machine learning on first training data, the first training data defining a relationship between the first information and the circuit parameter obtained for the first information when the number of the one or more bonding wires is one;
a second trained model generated by performing machine learning on second training data, the second training data defining a relationship between the first information and the circuit parameter obtained for the first information when the number of the one or more bonding wires is N1; and
a third trained model generated by performing machine learning on third training data, the third training data defining a relationship between the first information and the circuit parameter obtained for the first information when the number of the one or more bonding wires is N2, and
wherein, when the number of the one or more bonding wires indicated by the second information differs from one, N1, and N2, the estimating estimates the second parameter based on the second trained model from the first information, and estimates the third parameter based on the third trained model from the first information.

5. The non-transitory computer-readable storage medium according to claim 1,
wherein the trained model is one trained model generated by performing machine learning on a plurality pieces of training data, the plurality pieces of training data each defining a relationship of the first information and the number of the one or more bonding wires to the circuit parameter obtained for the first information and the number of the one or more bonding wires, and
wherein, when the number of the one or more bonding wires indicated by the second information differs from one, N1, and N2, the estimating estimates the second parameter based on the one trained model from the first information and N1 as the number of the one or more bonding wires, and estimates the third parameter based on the one trained model from the first information and N2 as the number of the one or more bonding wires.

6. The non-transitory computer-readable storage medium according to claim 1,
wherein the trained model is generated by performing machine learning on training data, the training data each defining a relationship of the first information and the number of the one or more bonding wires to the circuit parameter obtained for the first information and the number of the one or more bonding wires when the number of the one or more bonding wires is one, N1, N2, and N3, the N3 being more than N1 and less than N2, and
wherein, when the number of the one or more bonding wires indicated by the second information is less than N3, the estimating estimates a fourth parameter that is the circuit parameter when the number of the one or more bonding wires is N3, from the first information based on the trained model, and the calculating calculates the calculation parameter based on the second parameter and the fourth parameter, and
wherein, when the number of the bonding wires indicated by the second information is more than N3, the estimating estimates the fourth parameter, and the calculating calculates the calculation parameter based on the fourth parameter and the third parameter.

7. The non-transitory computer-readable storage medium according to claim 1,
wherein the one or more bonding wires includes at least three bonding wires connected side by side between the first port and the second port,
wherein intervals between adjacent bonding wires of the at least three bonding wires include one or more first intervals having a first length and one or more second intervals having a second length different from the first length,
wherein the second information includes a first number representing a number of the first intervals and a second number representing a number of the second intervals,
wherein the N1 corresponds to a case in which the first number is N1−1, and the N2 corresponds to a case in which the first number is N2−1,
wherein the estimating estimates, from the first information based on another trained model, at least one parameter of a fourth parameter that is the circuit parameter when the second number is M1 or a fifth parameter that is the circuit parameter when the second number is M2, and the calculating calculates the calculation parameter that is the circuit parameter for the first number and the second number indicated by the second information, based on the at least one parameter of the first parameter, the second parameter, or the third parameter and the at least one parameter of the fourth parameter or the fifth parameter from the second information, and
wherein the another trained model is generated by performing machine learning on another training data, the another training data each defining a relationship of the first information and the second number to the circuit parameter obtained for the first information and the second number when the second number is M1 and M2.

8. The non-transitory computer-readable storage medium according to claim 1,
wherein the one or more bonding wires includes at least three bonding wires connected side by side between the first port and the second port, and
wherein intervals between adjacent bonding wires of the at least three bonding wires are constant.

9. The non-transitory computer-readable storage medium according to claim 1,
wherein the acquiring acquires third information about a frequency of a high frequency signal transmitted between the first port and the second port,
wherein the estimating estimates the at least one parameter based on the trained model from the first information and the third information, and the calculating calculates the calculation parameter based on the at least one parameter from the second information, and
wherein the trained model is generated by performing machine learning on a plurality of pieces of training data, the plurality of pieces of training data each defining a relationship of the first information, the frequency, and the number of the one or more bonding wires to the circuit parameter obtained for the first information, the frequency, and the number of the one or more bonding wires when the number of the one or more bonding wires is one, N1, and N2.

10. The non-transitory computer-readable storage medium according to claim 1,
wherein the circuit parameter is an S-parameter, a Y-parameter, or a Z-parameter.

11. A calculation method comprising:
acquiring first information about one or more bonding wires other than a number of the one or more bonding wires, and second information about the number of the one or more bonding wires, the one or more bonding wires being connected side by side between a first port and a second port;
estimating, from the first information based on a trained model, at least one parameter of a first parameter that is a circuit parameter between the first port and the second port when the number of the one or more bonding wires is one, a second parameter that is the circuit parameter when the number of the one or more bonding wires is N1 that is two or more, or a third parameter that is the circuit parameter when the number of the one or more bonding wires is N2 that is more than N1; and
calculating a calculation parameter that is the circuit parameter for the number of the one or more bonding wires indicated by the second information, based on the at least one parameter from the second information,
wherein the trained model is generated by performing machine learning on training data, the training data defining a relationship of the first information and the number of the one or more bonding wires to the circuit parameter obtained for the first information and the number of the one or more bonding wires when the number of the one or more bonding wires is one, N1, and N2.

12. A calculation device comprising:
circuitry configured to:
acquire first information about one or more bonding wires other than a number of the one or more bonding wires, and second information about the number of the one or more bonding wires, the one or more bonding wires being connected side by side between a first port and a second port;
estimate, from the first information based on a trained model, at least one parameter of a first parameter that is a circuit parameter between the first port and the second port when the number of the one or more bonding wires is one, a second parameter that is the circuit parameter when the number of the one or more bonding wires is N1 that is two or more, or a third parameter that is the circuit parameter when the number of the one or more bonding wires is N2 that is more than N1; and
calculate a calculation parameter that is the circuit parameter for the number of the one or more bonding wires indicated by the second information, based on the at least one parameter from the second information,
wherein the trained model is generated by performing machine learning on training data, the training data each defining a relationship of the first information and the number of the one or more bonding wires to the circuit parameter obtained for the first information and the number of the one or more bonding wires when the number of the one or more bonding wires is one, N1, and N2.
